(19) United States
(12) Patent Application Publication
(10) Pub. No.: US 2025/0036983 A1
(43) Pub. Date: Jan. 30, 2025

(54) Method and System for Calibrating Uncertainty for Interactive Learning Using Modeled Cognitive Feedback via Machine Learning

(71) Applicant: The Government of the United States of America, as represented by the Secretary of the Navy, Arlington, VA (US)

(72) Inventors: Jaelle P. Scheuerman, Metairie, LA (US); Zachary A. Bishof, New Orleans, LA (US); Christopher J. Michael, Covington, LA (US)

(73) Assignee: The Government of the United States of America, as represented by the Secretary of the Navy, Arlington, VA (US)

(21) Appl. No.: 18/786,893

(22) Filed: Jul. 29, 2024

Related U.S. Application Data
(60) Provisional application No. 63/515,941, filed on Jul. 27, 2023.

(51) Int. Cl. G06N 7/01; G06N 20/00

(52) U.S. Cl. CPC G06N 7/01; G06N 20/00

(57) ABSTRACT

A method of reducing uncertainty in a machine learning model that may include providing a first set of visual data, and receiving user input associated with identifying a threshold point in the first set of visual data. The method may include identifying via a machine learning model, in the first set of visual data, a machine placement candidate point associated with identifying the threshold point, and training, by the processing device, baseline and cognitive uncertainty models. The method may include identifying via the trained baseline uncertainty model, one or more confidence values associated with a machine placement candidate point for a visual feature in a second set of visual data, and identifying via the trained cognitive uncertainty model, one or more confidence values associated with a machine placement candidate point for a visual feature in a second set of visual data, the visual feature being associated with the classification task.

### CROSS-REFERENCE

This Application is a nonprovisional application of and claims the benefit of priority under 35 U.S.C. § 119 based on U.S. Provisional Patent Application No. 63/515,941 filed on Jul. 27, 2023. The Provisional Application and all references cited herein is hereby incorporated by reference into the present disclosure in their entirety.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, DC 20375, USA; +1.202.767.7230; nrltechtran@us.navy.mil, referencing Navy Case #211683.

### TECHNICAL FIELD

The present disclosure is related to machine learning, and more specifically to, but not limited to improving uncertainty estimation in interactive machine learning environments through the use of human-tuned features derived from a cognitive model.

### BACKGROUND

Machine learning (ML) models operating in dynamic real world environments often experience degraded performance as the incoming data changes from the training set. If the concept drift is not addressed, it can lead to incorrect model based decisions. Adjusting for such changes in traditional ML systems usually requires monitoring the model performance and then completing slow and costly retraining when the performance falls below some threshold. Interactive learning opens up new opportunities for refining machine learning models in the face of concept drift, by training and improving models online through implicit feedback collected from user activity. However, this process relies on waiting for user feedback before the model can begin to improve, and this can often take more time and interaction than desired. When a system is slow to detect and respond to concept drift, it will be incorrect in its estimates of uncertainty. This can be especially problematic in workflows where an analyst is working to validate and correct machine generated labels.

Machine learning (ML) models operating in dynamic real world environments often experience degraded performance as the incoming data changes from the training set. If the data drift is not addressed, it can lead to incorrect model-based decisions. Adjusting for such changes in traditional ML systems usually requires monitoring the model performance and then completing slow and costly retraining when the performance falls below some threshold. In the following, we consider the importance of an accurate uncertainty model in identifying data drift in interactive machine learning (IML) systems, and suggest ways in which analysts and machine learning algorithms can work together to more quickly detect and address data drift.

IML combines active learning with online learning to interactively query a user about data points it is uncertain about. In IML systems, uncertainty models are used to sample labels that the system is not sure about, so that they can be validated by an analyst. This process relies on an uncertainty model that accurately estimates the probability of being wrong about a classification. If the model underestimates or overestimates the probability of a particular label, this can degrade the performance of the human-machine team. An overconfident model may make more mistakes by not prioritizing validation of labels that are wrong, while an under confident model may waste resources asking for validation when none is needed.

Unfortunately, uncertainty models do not always represent the probability of a label given the known data distribution. For example, in neural network models, a softmax function is commonly used to rank order label predictions. Softmax assigns values between 0-1 to predicted labels, such that those closer to 1 are considered more likely. However, the value itself may not be indicative of the underlying probability distribution. Alternative methods that map classifications to the underlying probability distribution of a validation set may also become inaccurate due to data drift, as the learned distribution is no longer representative of the incoming data.

Calibrating an uncertainty model in dynamic real world environment calls for interactive tools that build upon both the human and machine strengths to identify and adapt to different kinds of changes in the data. For example, automated methods can be used to adjust the uncertainty model when performance metrics fall below a threshold. However, relying on this method alone is slow to detect problems.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

The present disclosure provides for a method of reducing uncertainty in a machine learning model. The method may include providing, by a processing device, a first set of visual data, and receiving, by the processing device, user input associated with identifying a threshold point in the first set of visual data, the threshold point being associated with a classification task. The method may include identifying, by the processing device via a machine learning model, in the first set of visual data, a machine placement candidate point associated with identifying the threshold point, and identifying, by the processing device and based on the machine placement candidate point, a set of baseline confidence values via a baseline uncertainty model. The method may include identifying, by the processing device and based on the machine placement candidate point and modeled cognitive features, a second set of confidence values via a cognitive uncertainty model, and determining, by the processing device, an actual probability of machine incorrectness based on a distribution associated with machine placement candidate point and the user input associated with identifying the threshold point. The method may include determining, by the processing device, via a baseline uncertainty model, a first prediction that the machine placement candidate point is incorrect, and determining, by the processing device, via a cognitive uncertainty model, a second prediction that the machine placement candidate point is incorrect based on cognitive features associated with a location of the threshold point. The method may include training, by the processing device, the baseline uncertainty model, based on the actual probability of machine incorrectness and the first prediction that the machine placement candidate point is incorrect, wherein the training is based on baseline features associated with the location of the threshold point. The method may include training, by the processing device, the cognitive uncertainty model, based on the actual probability of machine incorrectness and the second prediction that the machine placement is incorrect, wherein the training is based on cognitive features associated with the location of the threshold point. The method may include identifying, by the processing device, via the trained baseline uncertainty model, one or more confidence values associated with a machine placement candidate point for a visual feature in a second set of visual data, the visual feature being associated with the classification task. The method may include identifying, by the processing device, via the trained cognitive uncertainty model, one or more confidence values associated with a machine placement candidate point for a visual feature in a second set of visual data, the visual feature being associated with the classification task.

### BRIEF DESCRIPTION OF THE DRAWINGS

FIG. 1 illustrates an exemplary interactive machine learning paradigm coupling machine learning to a human analyst, in accordance with one or more disclosed aspects.

FIG. 2 illustrates an example cognitive model paradigm along with a human in the loop, in accordance with one or more disclosed aspects.

FIG. 3 illustrates an example visual depiction of how the ACT-R simulation generates timing information for the signal threshold detection task, in accordance with one or more aspects described herein.

FIG. 4 illustrates an example cognitive uncertainty model schematic system flow diagram, in accordance with one or more aspects described herein.

FIG. 5 illustrates exemplar graphs from the five different phases from a threshold selection task, in accordance with one or more aspects described herein.

FIG. 6 illustrates a comparison of the mean absolute error of the baseline uncertainty model and the cognitive uncertainty model at a tolerance of 0.08, in accordance with one or more disclosed aspects.

FIG. 7 illustrates a comparison of the mean absolute error of the baseline uncertainty model and the cognitive uncertainty model at a tolerance of 0.1, in accordance with one or more disclosed aspects.

FIG. 8 illustrates a comparison of the mean absolute error of the baseline uncertainty model and the cognitive uncertainty model across a range of tolerance values, in accordance with one or more disclosed aspects.

FIG. 9 illustrates a comparison of the mean absolute error of the baseline uncertainty model and the cognitive uncertainty model across a range of tolerance values, in accordance with one or more disclosed aspects.

FIG. 10 illustrates an example method in accordance with one or more disclosed aspects.

FIG. 11 illustrates an example computer system, in accordance with one or more disclosed aspects.

### DETAILED DESCRIPTION

The aspects and features of the present aspects summarized above can be embodied in various forms. The following description shows, by way of illustration, combinations and configurations in which the aspects and features can be put into practice. It is understood that the described aspects, features, and/or embodiments are merely examples, and that one skilled in the art may utilize other aspects, features, and/or embodiments or make structural and functional modifications without departing from the scope of the present disclosure.

Disclosed embodiments address the drawbacks of current and prior systems discussed above. For example, it would be better to collect feedback about how well the uncertainty model is calibrated as part of the analyst's validate and correct workflow, as well as provide some method for the analyst to show how underlying features have changed. In our research, we have demonstrated this potential in an interactive learning task where user feedback successfully calibrates an uncertainty model to be more representative of the underlying probability distribution in a changing environment. Collecting this type of feedback opens up new directions for improving models quickly in online dynamic environments.

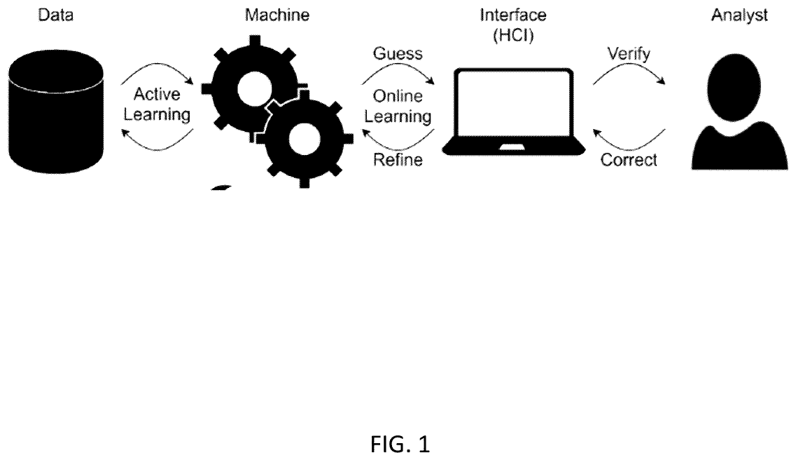

FIG. 1 illustrates an exemplary interactive machine learning paradigm coupling machine learning to a human analyst, in accordance with one or more disclosed aspects.

Interactive machine learning (IML) can be built around an analyst's validate and correct workflow to train a model from analyst's feedback. IML can depend on an accurate uncertainty model to generate dependable predictions or alert the analyst if a classification is likely to be incorrect. Concept drift include changes in the probabilities that can lead to the model being overconfident or underconfident in its predictions.

Many interactive learning environments use some measure of uncertainty to estimate how likely the model output is to be correct. The reliability of these estimates is diminished when changes in the environment cause incoming data to drift away from the data the model was trained on. While interactive learning approaches can use implicit feedback to help tune machine learning models to identify and respond to concept drift more quickly, this approach still requires waiting for user feedback before the problem of concept drift can be addressed. Disclosed embodiments provide that modeled cognitive feedback can supplement implicit feedback by providing human-tuned features to train an uncertainty model that is more resilient to concept drift. Disclosed embodiments provide for using modeled cognitive feedback to support interactive learning, and show that an uncertainty model with cognitive features performs better than a baseline model in an environment with concept drift.

### 1. Introduction

In some situations, uncertainty models can be used to prioritize what labels are shown to the analyst without overwhelming them with too many incorrect guesses (Michael et al., 2020). This process relies on an uncertainty model that accurately estimates the probability of being wrong about a classification. If the model underestimates or overestimates the probability of a particular label, this can degrade the performance of the human-machine team. Disclosed embodiments use modeled cognitive feedback to supplement user feedback to tune an uncertainty model to more accurately reflect the data distribution in a changing environment. First, we will introduce the challenges of representing uncertainty in interactive learning environments. We will then provide some background on cognitive models and how they have been used to support both interactive and machine learning systems, and discuss how they could be used to more quickly adapt to concept drift in interactive learning environments. Finally, we will describe a proof of concept where we compare two uncertainty models in an online learning task and show that one incorporating cognitive features derived from modeled visual search is more accurate over time than one using more traditional features.

### 2. Background

### 2.1. Uncertainty in Interactive Learning

We consider the challenge of representing uncertainty in an interactive learning system where an analyst is working closely with a machine learning system to validate and correct labels. Uncertainty is often not well-defined, but it is often assumed to be some measure of what is unknown (Weinhardt & Schaefer, 2022) Here we define it as the probability of machine incorrectness. This measure is used in active learning to identify examples that would be the most impactful in training a supervised model, minimizing the number of examples that the analyst must label or validate to help the model converge (Cohn et al., 1994). When an uncertainty model is inaccurate, it leads to a model that is either underconfident or overconfident. An overconfident model may make more mistakes by not prioritizing the validation of labels that are wrong, while an underconfident model may waste resources asking for validation when none is needed. Calibrating an uncertainty model in a dynamic real world environment calls for interactive tools that build upon both the human and machine strengths to identify and adapt to different kinds of change in the data. For example, automated methods can be used to adjust the uncertainty model when performance metrics fall below a threshold (Bayram et al., 2022), but relying on this method alone is slow to detect problems.

Interactive learning environments offer alternative ways to detect concept drift by using explicit and implicit feedback collected from a user who may identify changes in the environment or a drop in machine classification accuracy before the automated methods. However, waiting for user feedback is still not ideal, since the uncertainty model is likely already inaccurate by the time the user can identify the problem and provide feedback.

Disclosed embodiments provide a new approach for providing cognitive feedback to calibrate an uncertainty model. This approach builds on previous work using cognitive models to design adaptive interfaces and machine learning models that must be built upon some understanding of human behavior.

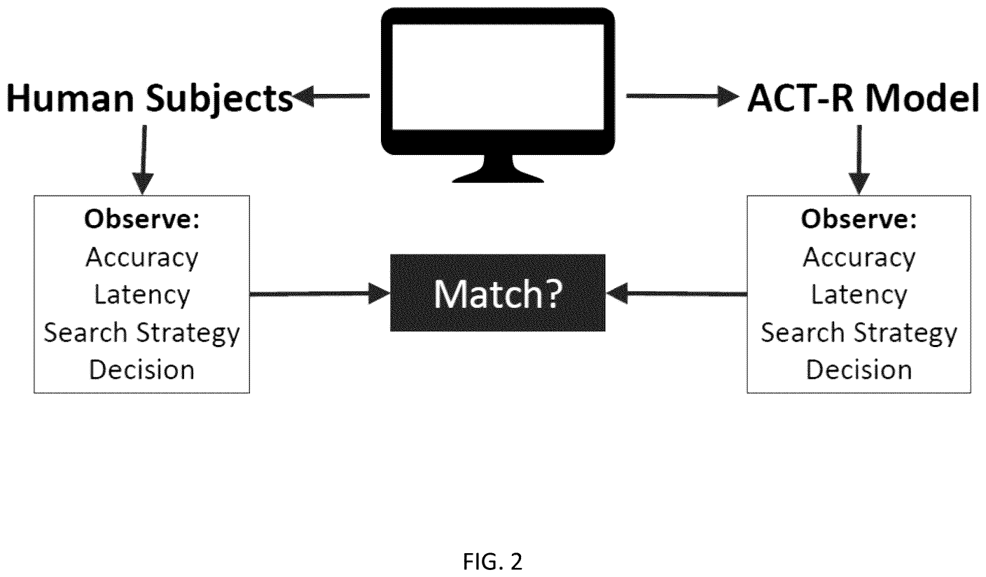

To address this gap, disclosed embodiments employ cognitive models to provide modeled cognitive feedback to tune an uncertainty model. FIG. 2 illustrates an example cognitive model paradigm along with a human in the loop. Cognitive models are algorithmic representations of clearly defined theories about cognitive functions, such as memory, learning or attention. These models often build upon cognitive architectures, such as ACT-R (Adaptive Control of Thought-Rationale), which provide access to empirically validated modules for simulating cognitive functions such as declarative memory, visual attention, auditory attention and motor abilities (Anderson, J. R. et al. An Integrated Theory of the Mind. Psychological review 111, 1036-1060 (2004). When models build upon architectures like ACT-R, they provide a hypothesis as to how humans would respond to specific tasks involving the cognitive functions modeled by that architecture. The result is a simulation of baseline human performance for the modeled task. Simulated interactions with an interactive interface can provide feedback to train a machine learning model.

Previous work has examined using features derived from psychological theories to improve machine learning models of decision making (Plonsky, O., Erev, I., Hazan, T. & Tennenholtz, M. Psychological Forest: Predicting Human Behavior. (2016) doi: 10.2139/ssrn.2816450), and using cognitive models to generate synthetic data to support model training (Bourgin, D. D., Peterson, J. C., Reichman, D., Russell, S. J. & Griffiths, T. L. Cognitive Model Priors for Predicting Human Decisions. in International Conference on Machine Learning 5133-5141 (PMLR, 2019)) and (Trafton, J. G., Hiatt, L. M., Brumback, B. & McCurry, J. M. Using Cognitive Models to Train Big Data Models with Small Data. in Proceedings of the 19th International Conference on Autonomous Agents and MultiAgent Systems 1413-1421 (2020)).

Disclosed aspects expand upon and improve these concepts by showing how features derived from a cognitive model of an interactive task can be used to improve an uncertainty model's performance in an environment with concept drift.

### 2.2. Cognitive Modeling for Human-Attuned Interfaces

Cognitive models are built upon clearly defined theories about aspects of cognition, such as memory, learning or attention. They provide an algorithmic representation of a psychological theory that simulates a measurable aspect of human performance (i.e. reaction time, accuracy). The resulting simulation can be compared to real human performance to validate the model's strengths and weaknesses (Lewandowsky & Farrell, 2010). Many cognitive models leverage existing cognitive architectures in their design. Cognitive architectures represent a specific theory about how human minds are structured, allowing them to learn, reason, and/or perceive the environment. These, too, have been developed through systematic evaluation against human performance in psychological studies. Many cognitive architectures exist, each with their own design choices. For example, SOAR is a cognitive architecture that incorporates several modules that run in parallel and are controlled by procedural rule-based system. It differentiates between working, episodic, and semantic memory and incorporates visuospatial and motor modules to control virtual effectors (Laird et al., 1986).

ACT-R is another architecture that incorporates modules that represent a variety of aspects of cognition, including declarative memory, visual attention, auditory attention and motor functions. These modules can run in parallel around a central, rule-based control system (Anderson et al., 2004). Many other architectures exist beyond these two, each with their own strengths and weaknesses. Recent work has considered how to unify these into a common computational framework that represents theory where architectures generally agree (Laird et al., 2017). By building upon cognitive architectures that have been validated against human performance, a cognitive model can provide a hypothesis as to how humans would respond to specific tasks involving the cognitive functions modeled by that architecture. Cognitive models support the design of human-attuned interfaces by providing a baseline algorithmic representation of human cognitive abilities and limitations.

In the following sections, we will explore how research in human factors and machine learning has previously leveraged cognitive models to create human-attuned interfaces and models. We will then consider the potential for cognitive models in providing feedback for interactive learning. Finally, we will introduce the challenges in representing uncertainty in interactive learning workflows and consider how modeled cognitive feedback can help machine learning models respond more rapidly to concept drift.

### 2.2.1. Cognitive Models in Human Factors Research

Human Factors research has a long history of incorporating cognitive models. Often this is done to help define a specific theory that can explain some observed aspect of human performance and test how changes to the interface or environment might affect performance. In turn, this can be used to improve the system or interface that a user interacts with. In Salvucci (2006), researchers developed a model of a car driver in ACT-R. The model could account for the steering behavior and gaze distributions of human drivers in a multilane highway environment. The work provided an initial example of applying models designed in ACT-R to complex, realistic tasks. In another example, Fleetwood & Byrne (2006) developed an ACT-R model of visual search to describe how participants of an eye tracking study searched the screen for an icon. The model was used to explain both response time and eye movement data. In another study, researchers used psychological theories and eye tracking data to develop an ACT-R model to simulate the relative difficulty in recognizing different messages in grouped bar charts (Burns et al., 2013). In Lohrenz et al. (2009), cognitive models of clutter were developed to explain people's subjective ratings of clutter on geospatial displays. This model was used to help evaluate whether a geospatial display would be considered too cluttered by its intended audience. Cognitive models have also been developed to model visual search patterns and timings for familiar layout designs. By incorporating learning and memory into the model, it was possible to predict when layouts become familiar or forgotten and predict how much a familiar layout might impact a user's visual search behavior when exploring a new unfamiliar layout (Todi et al., 2018).

### 2.2.2. Cognitive Models in Machine Learning Research

Machine learning has also benefited from incorporating features and simulated data from cognitive models. For example, Plonsky et al. (2016) extended a random forest algorithm to include psychological features in addition to more standard and naive features. In a choice prediction competition, the resulting model significantly outperformed other models built upon best practices. To address the challenge of predicting human decisions, which often require huge datasets to accurately model with off the shelf techniques, Bourgin et al. (2019) generated data from cognitive models of decision making and used these to pretrain a neural network. The network was later fine-tuned using a smaller sample of real human decision making data. This approach led to improvements on two benchmark datasets. (Trafton et al., 2020) also explored generating synthetic data to support machine learning models of human behavior. This research explored using ACT-R models explaining different strategies of behavior in a supervisory control task to generate synthetic data to supplement real human data when training a convolutional network. The best results were achieved by combining real human data with synthetic data generated from the different strategies, which performed better than models trained off empirical or synthetic data alone.

### 2.3. Cognitive Models for Interactive Learning

We have reviewed several examples of how cognitive models can simulate human cognitive abilities to help make human factors decisions. We also explored past research showing how cognitive models can reduce the amount of real human data required to create machine learning models with equivalent or better performance of those trained on human data alone. Modeled cognitive feedback for interactive learning could build upon this work by simulating cognitive aspects of interfacing with an interactive learning system and looking at measurable metrics, such as fixation locations in a visual search or the reaction time to find and select a button. This information can be incorporated as an additional feature into the machine learning model, or as feedback to a reinforcement learning algorithm. Changes in modeled reactions could be an indication that something about the underlying environment has also changed so that the uncertainty model can adapt even before an active learning algorithm selects a data point to query the user about.

We will now introduce a task designed to compare uncertainty models in an interactive learning environment with concept drift.

### 3. Threshold Selection Task

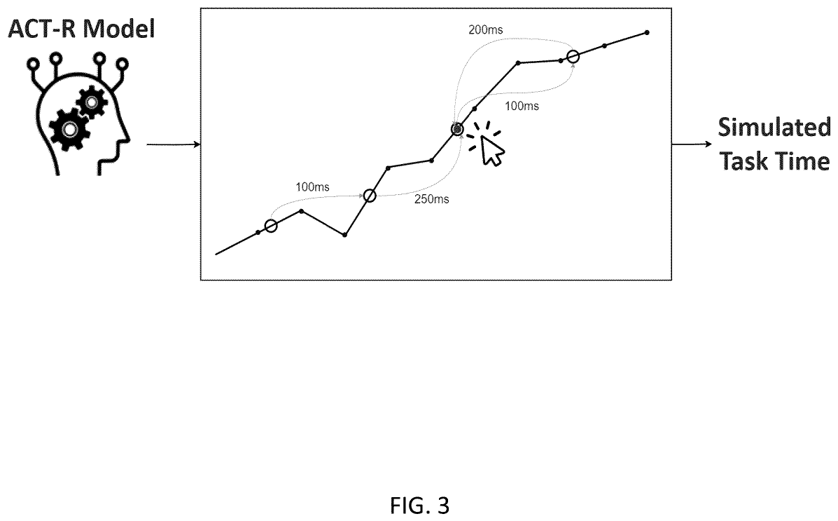

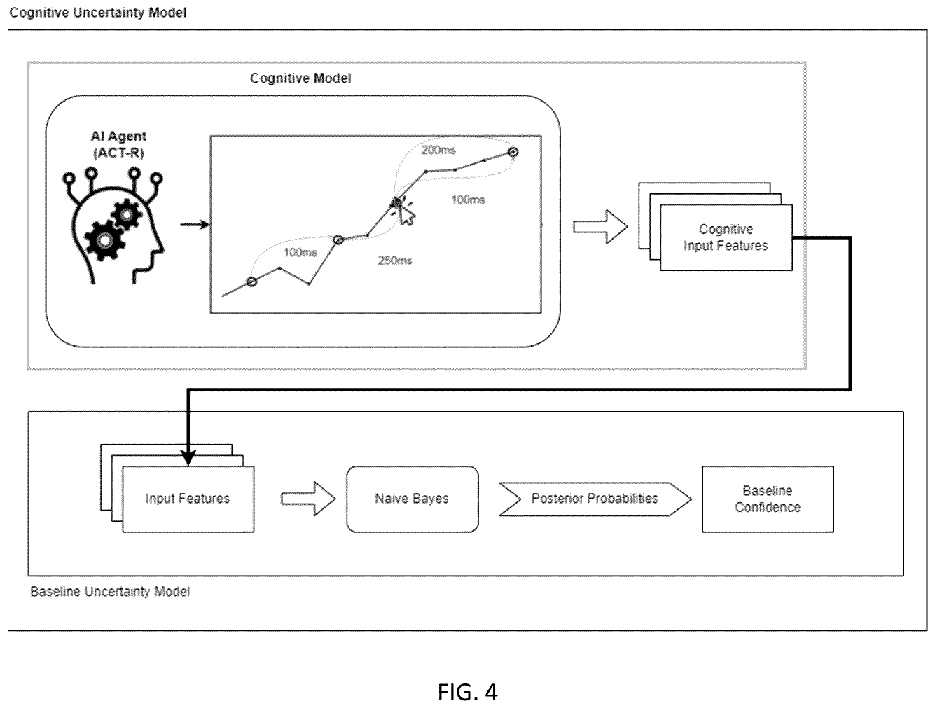

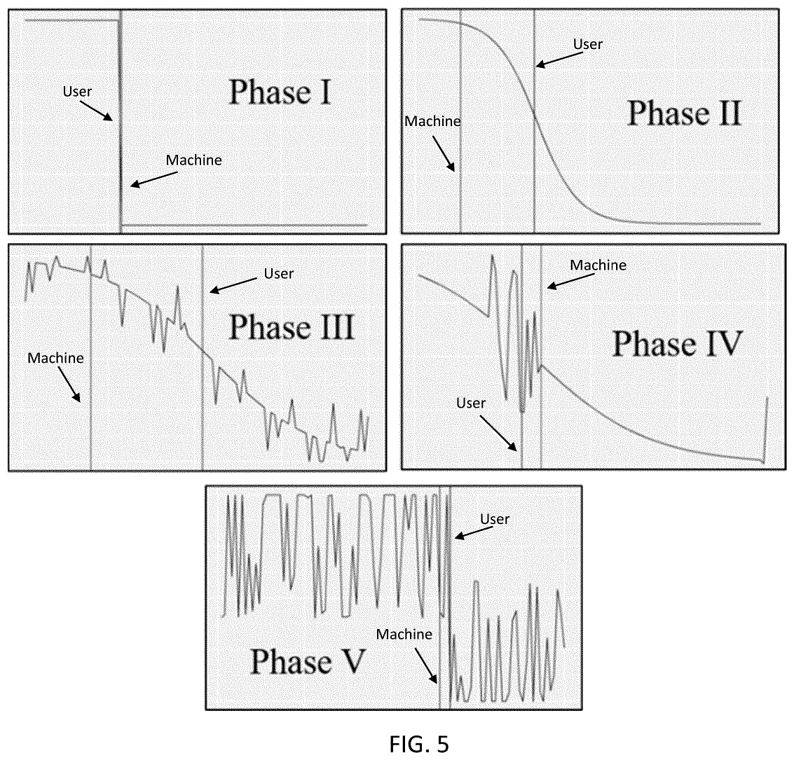

FIG. 3 is a visual depiction of how the ACT-R simulation generates timing information for the signal threshold detection task in accordance with one or more aspects described herein. FIG. 4 illustrates an example cognitive uncertainty model schematic system flow diagram in accordance with one or more aspects described herein. FIG. 5 illustrates exemplar graphs from the five different phases from a threshold selection task.

A threshold selection task is designed to explore methods of evaluating uncertainty as a probability of machine correctness. For example, a threshold detection task may be designed to evaluate using modeled cognitive feedback to calibrate uncertainty in interactive environments with concept drift. The goal of this task is to iteratively consider several examples of noisy signal graphs and locate the threshold where the signal no longer appears to be high. For each graph, a naïve Bayes model guesses where the threshold will be and an uncertainty model generates a confidence score representing the expected probability of machine correctness. An analyst also clicks the point they think best represents the threshold, and features about that location are used as input to the naïve Bayes for future trials. The clicks also provide a ground truth response that is used to evaluate the correctness of the placement prediction.

In some cases, the goal of a task is to locate the threshold on a noisy signal graph where the signal no longer appears to be high. The signal graph is designed as a sigmoid curve with varying degrees of noise, and the user can select any point along the curve that they think is the point of inflection. This task was designed to provide an intuitive problem where the machine learning algorithm predicts the threshold location that a user would choose. Over the course of several examples, the machine learning model guesses where the threshold will be and then the user clicks the point they think best represents the threshold.

In one example, throughout the task, the user is presented with graphs generated from 5 sets of signal types. To simulate completing the task in an environment with concept drift, examples were generated from the 5 sets of signal types. Each signal type incorporate noise into the sigmoid differently to introduce concept drift (see FIG. 5 for examples). Each of the 5 sets contains 7 trials, respectively, where noise is generated in that same way. The user and machine team complete 30 realizations, where each realization represents stepping through the 5 sets of trials for a total of 35 trials. By collecting data over 30 realizations, we can consider the distribution of machine and user placements to calculate the probability of machine correctness and compare it to the confidence score produced by the uncertainty model.

We will now describe the classifier used to select the machine placements from which the uncertainty models predict a confidence value (probability of correctness).

### 3.1. Classifier

To understand the effectiveness of using modeled cognitive feedback to calibrate an uncertainty model, we first developed a baseline uncertainty model. The baseline uncertainty model can use naïve Bayes, in one example, to predict the probability of machine incorrectness using several features chosen from standard feature selection techniques. A tolerance value is incorporated such that any point within some distance of a user placement is considered a correct placement. Lower placement tolerances should lead to lower expected accuracy. Points within the tolerance distance are labeled as 1 and the rest are labeled as 0.

A naïve Bayes classifier predicts the user placements using several features chosen from standard feature selection techniques. To train the classifier, labels were determined by assigning 1 to all sample points with x-coordinates less than or equal to the human placed threshold and 0 to the remaining points. While naïve Bayes is described, other classifiers can be used, such as Kernel Density Estimation, Induction, Constant Model, and/or the like.

### 3.2. Cognitive Model

In addition to generating machine placements, we designed a cognitive model to generate cognitive features for each trial that were provided to the cognitive uncertainty model.

The cognitive model was developed to generate modeled feedback about the signal threshold in each trial by simulating a user completing the visually scanning and encoding a sigmoid curve and then clicking a point along the curve. The resulting performance metrics were used as input features to a cognitive uncertainty model.

The model simulates a user visually scanning and encoding a sigmoid curve. We designed the cognitive model in ACT-R, using the EMMA (Eye Movement Measurement and Analysis) extension. EMMA extends ACT-R to include basic functionality to generate quantitative predictions about eye movements, including the timing of those movements (Salvucci, 2001).

The ACT-R agent is designed to simulate the eye movements that occur as a user scans along the sigmoid curve and selecting a specific point as the inflection point. Since the location of the inflection point is subjective, depending on a user's preferences, our ACT-R agent does not simulate the decision of choosing a point and instead chooses one at random.

From the simulation, we were able to extract timing information about the task, including the total amount of time spent scanning the curve to points that were fixated upon long enough to be encoded. We used this information to design three cognitive features for our uncertainty model. These are defined below and were generated for each x-coordinate along the sigmoid.

scan-time (t): The amount of time that passed between trial start and a fixation point along the sigmoid curve, as calculated by EMMA. The number of points that were fixated upon, and therefore the number of total points along the line with associated scan-time values, varied depending on the shape and noise level of the sigmoid. All other scan-time values are set to 0.

extrapolated-time (tₑ): A timing calculated from the scan-time that assigns an extrapolated-time to every x-coordinate position pos(x) between the two fixatation positions (pos(p₀) and pos(p₁)). The extrapolated time tₑ can be calculated as:

$${t}_{e} = t ( {p}_{0} ) + \frac{pos ( x ) - pos ( {p}_{0} )}{t ( {p}_{1} ) - t ( {p}_{0} )}$$

prev-time (t₋₁): Each points t₋₁ value is set to the scan-time (t) for the associated x-coordinate if it exists. Otherwise, it is set to the scan-time (t) associated with the nearest x-coordinate less than the current x-coordinate and has a scan-time value associated with it.

next-time (t₁): Each points t₁ value is set to the scan-time (t) for the associated x-coordinate if it exists. Otherwise, it is set to the scan-time (t) associated with the next lowest x-coordinate that has an associated scan-time value.

### 3.3. Uncertainty Model

These timing metrics are used as cognitive features (scan-time, extrapolated-time, prev-time, and next-time) provided as input to an uncertainty model along with the baseline features. For each trial, the cognitive uncertainty model uses the input features of the trials seen so far to generate an uncertainty value. We define uncertainty to be the probability that the predicted machine placement is incorrect. The uncertainty value can be used to report machine confidence, which is defined as confidence=1−uncertainty, representing the probability of machine correctness.

### Baseline Uncertainty Model

To examine the effectiveness of using cognitive features in our uncertainty model, we compare two versions of the uncertainty model. The first version is a baseline uncertainty model. This model also naive Bayes, and draws heavily from the classifier model.

However, it differs from the classifier in that the uncertainty model allows some placement tolerance such that any point within some distance of a user placement is considered a correct placement. Lower placement tolerances should lead to lower expected accuracy. Points within the tolerance distance are labeled as 1 and the rest are labeled as 0.

### Cognitive Uncertainty Model

The second version of the uncertainty model is built in the same way as the baseline uncertainty model, except now we are using three additional cognitive features (scan-time, extrapolated-time, and next time) derived from the line scan model described above in Section 3.2.

### 4. Results

We consider the advantages of a cognitive uncertainty model by comparing it to the baseline uncertainty model. For both uncertainty models, confidence scores are generated for each trial's machine placement prediction. Mean absolute error is then calculated by comparing the confidence scores predicted by each uncertainty model to the actual probability of machine correctness observed in the task.

The described method to calibrate uncertainty using modeled cognitive feedback has been implemented and tested against a baseline model that predicts the probability of machine incorrectness using only the baseline features not derived from the cognitive model.

Confidence values of both the cognitive uncertainty and baseline models were calculated as follows:

For each trial in the threshold selection task, the actual probability of machine incorrectness (P(A)) was calculated from the distributions of machine and human placements in the dataset. A tolerance parameter sets how close the machine placement must be to the human placement to be correct.

The baseline uncertainty model uses the baseline features of trials seen so far to predict the probability the machine placement is incorrect (P(B)). This is converted to a confidence value, c=1−P (B).

The cognitive uncertainty model uses the cognitive and baseline features of the trials seen so far to predict the probability that the machine placement is incorrect (P(C)), c=1−P (C).

Mean absolute error (MAE) was used to evaluate the confidence values predicted by the cognitive uncertainty model against the baseline model.

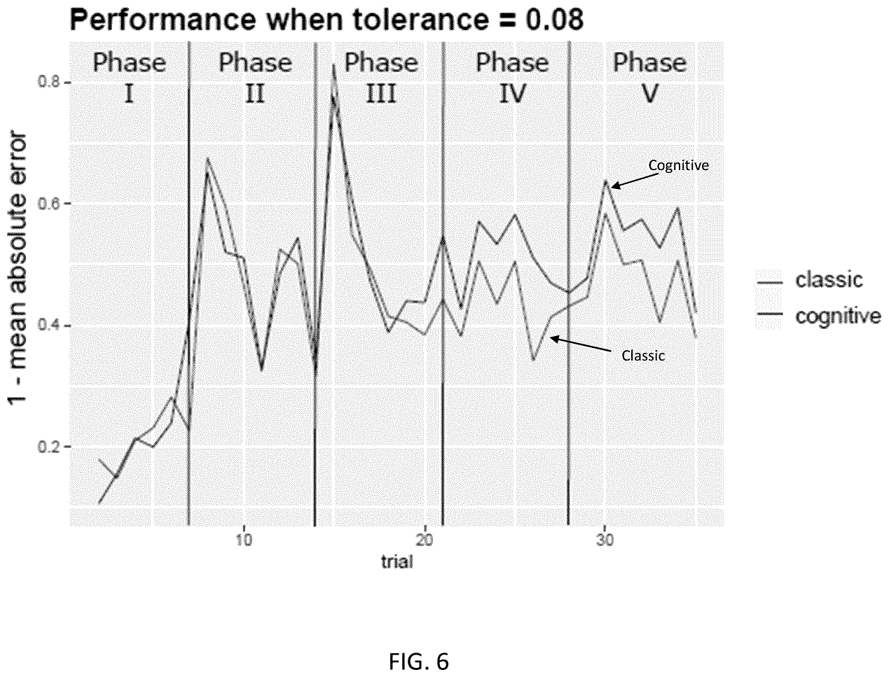

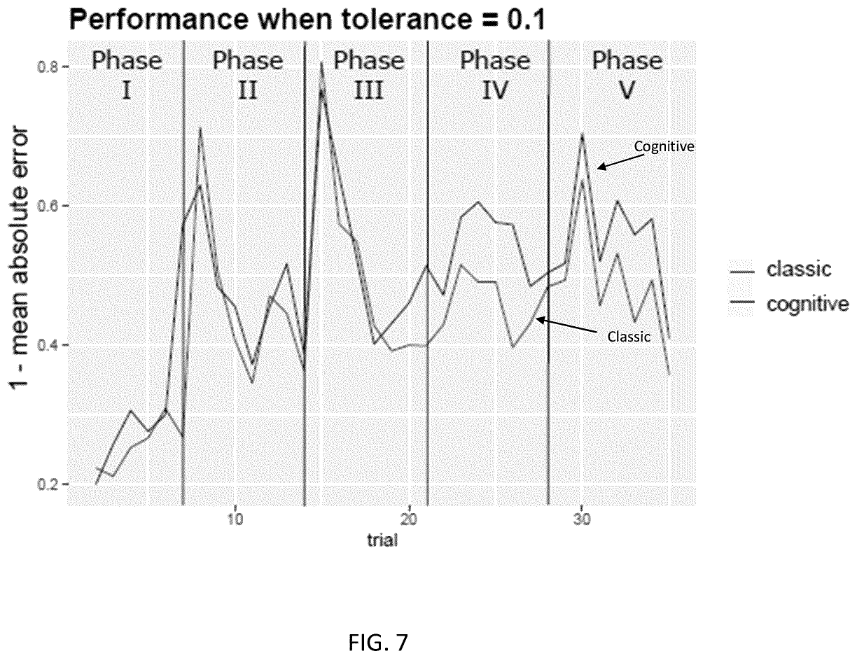

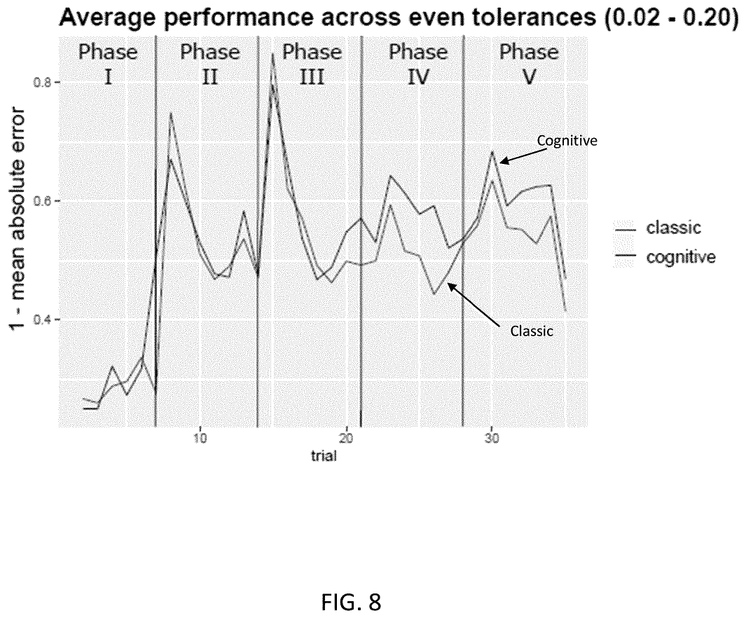

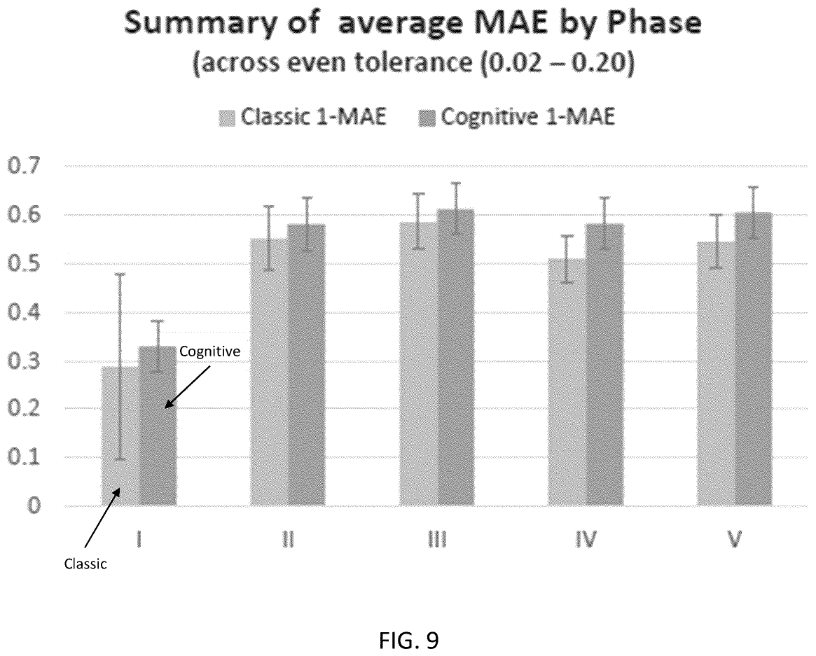

The two uncertainty models described above were used to generate confidence scores for the machine placements generated from the classifier. We evaluated the confidence scores by comparing them to the probability of machine correctness using the mean absolute error. By comparing the mean absolute error of the baseline uncertainty model to that of the cognitive uncertainty model, we see that while the models are comparable in early trials, the cognitive uncertainty model trends towards being a better predictor of machine correctness over time (see FIGS. 6-9). Recall that both uncertainty models made use of a tolerance parameter that configures how close a machine placement needs to be to the user's chosen inflection point to be considered correct. When we consider the average mean absolute error of both uncertainty models at different tolerances, we see the same trend, with the cognitive uncertainty model outperforming the baseline uncertainty model in the latter half of the trials (see FIGS. 8 and 9).

FIGS. 8 and 9 show a comparison of the mean absolute error of the baseline uncertainty model and the cognitive uncertainty model across a range of tolerance values. Recall that the tolerance parameter configures how close a machine placement needs to be to the user's chosen inflection point to be considered correct. The results show that although the models are comparable in early trials, the cognitive uncertainty model trends towards being a better predictor of machine correctness in later trials. This indicates that the cognitive uncertainty model required some trials to train on the cognitive features, but was more resilient than the baseline model to changes in the signal data as it became noisier.

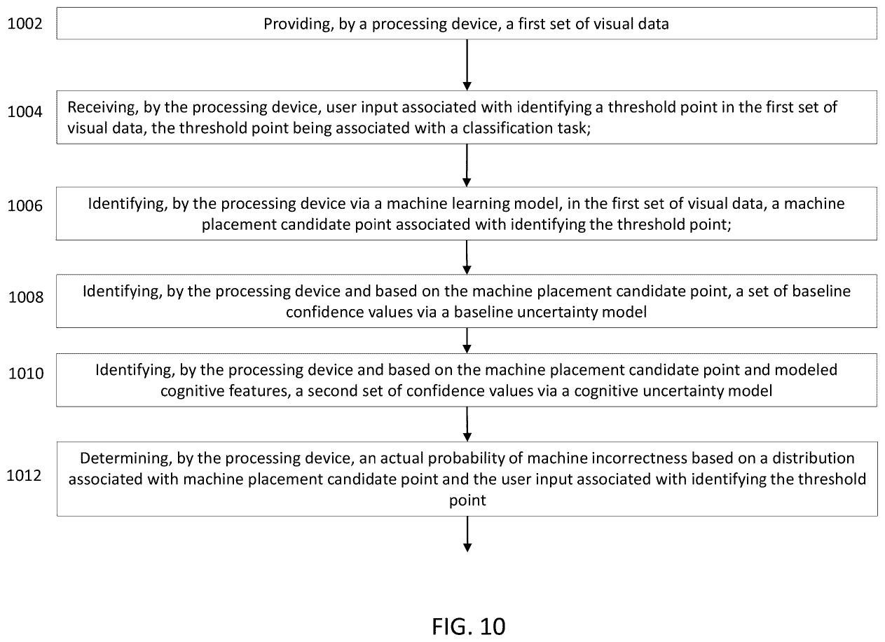

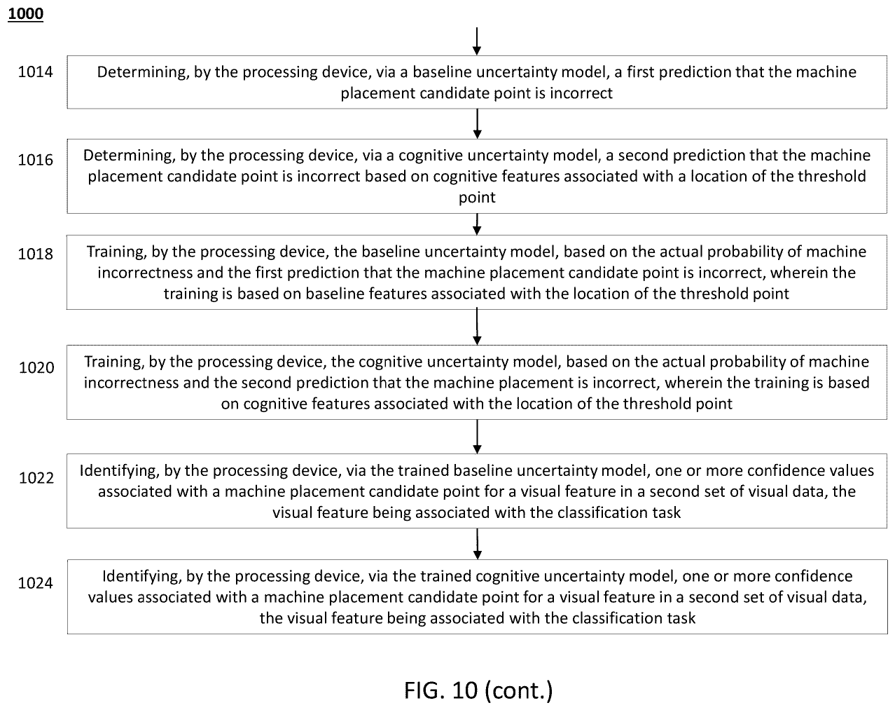

FIG. 10 illustrates an example method 1000, in accordance with one or more disclosed aspects. For example, method 1000 may be a method of reducing uncertainty in a machine learning model. Step 1002 may include providing, by a processing device, a first set of visual data. Step 1004 may include receiving, by the processing device, user input associated with identifying a threshold point in the first set of visual data, the threshold point being associated with a classification task. Step 1006 may include identifying, by the processing device via a machine learning model, in the first set of visual data, a machine placement candidate point associated with identifying the threshold point. Step 1008 may include identifying, by the processing device and based on the machine placement candidate point, a set of baseline confidence values via a baseline uncertainty model. Step 1010 may include identifying, by the processing device and based on the machine placement candidate point and modeled cognitive features, a second set of confidence values via a cognitive uncertainty model. Step 1012 may include determining, by the processing device, an actual probability of machine incorrectness based on a distribution associated with machine placement candidate point and the user input associated with identifying the threshold point. Step 1014 may include determining, by the processing device, via a baseline uncertainty model, a first prediction that the machine placement candidate point is incorrect. Step 1016 may include determining, by the processing device, via a cognitive uncertainty model, a second prediction that the machine placement candidate point is incorrect based on cognitive features associated with a location of the threshold point. Step 1018 may include training, by the processing device, the baseline uncertainty model, based on the actual probability of machine incorrectness and the first prediction that the machine placement candidate point is incorrect, wherein the training is based on baseline features associated with the location of the threshold point. Step 1020 may include training, by the processing device, the cognitive uncertainty model, based on the actual probability of machine incorrectness and the second prediction that the machine placement is incorrect, wherein the training is based on cognitive features associated with the location of the threshold point. Step 1022 may include identifying, by the processing device, via the trained baseline uncertainty model, one or more confidence values associated with a machine placement candidate point for a visual feature in a second set of visual data, the visual feature being associated with the classification task. Step 1024 may include identifying, by the processing device, via the trained cognitive uncertainty model, one or more confidence values associated with a machine placement candidate point for a visual feature in a second set of visual data, the visual feature being associated with the classification task. One or more steps may be repeated, added, modified, and/or excluded.

According to some aspects, one or more disclosed aspects may be used to facilitate a water-based operation. In some cases, disclosed aspects may provide information (e.g., identification of a shore line, water-based interfaces, land/water interfaces, air/water/land interfaces, other interfaces, transitions, regions, objects, etc. in images, and/or the like), and in some cases the additional information may be used for search & rescue, for safety of navigation, for military situational awareness, for implementing and/or developing a mission route plan associated with operating a vehicle, aircraft, vessel, and/or the like. In some cases, one or more disclosed aspects may be used to facilitate a strategic operation, which can include a defensive tactical operation or naval operation.

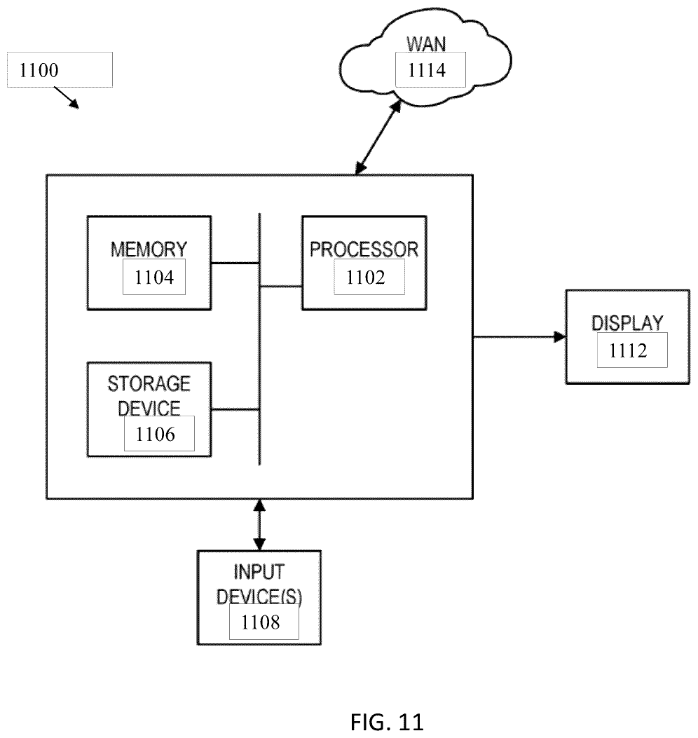

One or more aspects described herein may be implemented on virtually any type of computer regardless of the platform being used. For example, as shown in FIG. 11, a computer system 1100 includes a processor 1102, associated memory 1104, a storage device 1106, and numerous other elements and functionalities typical of today's computers (not shown). The computer 1100 may also include input means 1108, such as a keyboard and a mouse, and output means 1112, such as a monitor or LED. The computer system 1100 may be connected to a local may be a network (LAN) or a wide may be a network (e.g., the Internet) 1114 via a network interface connection (not shown). Those skilled in the art will appreciate that these input and output means may take other forms.

Further, those skilled in the art will appreciate that one or more elements of the aforementioned computer system 1100 may be located at a remote location and connected to the other elements over a network. Further, the disclosure may be implemented on a distributed system having a plurality of nodes, where each portion of the disclosure (e.g., real-time instrumentation component, response vehicle(s), data sources, etc.) may be located on a different node within the distributed system. In one embodiment of the disclosure, the node corresponds to a computer system. Alternatively, the node may correspond to a processor with associated physical memory. The node may alternatively correspond to a processor with shared memory and/or resources. Further, software instructions to perform embodiments of the disclosure may be stored on a computer-readable medium (i.e., a non-transitory computer-readable medium) such as a compact disc (CD), a diskette, a tape, a file, or any other computer readable storage device. The present disclosure provides for a non-transitory computer readable medium comprising computer code, the computer code, when executed by a processor, causes the processor to perform aspects disclosed herein.

Embodiments for reducing uncertainty in a machine learning model have been described. Although particular embodiments, aspects, and features have been described and illustrated, one skilled in the art may readily appreciate that the aspects described herein are not limited to only those embodiments, aspects, and features but also contemplates any and all modifications and alternative embodiments that are within the spirit and scope of the underlying aspects described and claimed herein. The present application contemplates any and all modifications within the spirit and scope of the underlying aspects described and claimed herein, and all such modifications and alternative embodiments are deemed to be within the scope and spirit of the present disclosure.

### REFERENCES

Anderson, J. R., Bothell, D., Byrne, M. D., Douglass, S., Lebiere, C., and Qin, Y. An integrated theory of the mind. Psychological review, 111 (4): 1036-160 October 2004. ISSN 0033-295X.
Bayram, F., Ahmed, B. S., and Kassler. A. From concept drift to model degradation: An overview on performance-aware drift detectors. Knowledge-Based Systems. pp. 108632. 2022.
Bourgin, D. D., Peterson, J. C., Reichman, D., Russell. S. J., and Griffiths, T. L. Cognitive model priors for predicting human decisions. In International Conference on Machine Learning, pp. 5133-5141. PMLR, 2019.
Burns. R., Carberry, S., and Schwartz, S. E. Modeling a graph viewer's effort in recognizing messages conveyed by grouped bar charts. In Carberry, S., Weibelzahl, S., Micarelli, A., and Semeraro, G. (eds.). User Modeling, Adaptation, and Personalization, pp. 114-126. Berlin. Heidelberg, 2013. Springer Berlin Heidelberg. ISBN 978-3-642-38844-6.
Cohn, D., Atlas, L., and Ladner, R. Improving generalization with active learning. Machine learning, 15:201-221, 1994.
Fleetwood, M. D. and Byrne, M. D. Modeling the visual search of displays: A revised ACT-R model of icon search based on eye-tracking data. Human-Computer Interaction. 21 (2): 153-197. 2006.
Laird, J. E, Newell, A., and Rosenbloom, P. S. SOAR: An architecture for general intelligence. Technical report. Stanford University. CA. Dept of Computer Science.
Laird, J. E., Lebiere, C., and Rosenbloom, P. S. A standard model of the mind: Toward a common computational framework across artificial intelligence, cognitive science, neuroscience, and robotics. Ai Magazine, 38 (4): 13-26, 2017.
Lewandowsky, S. and Farrell, S. Computational Modeling in Cognition: Principles and Practice. SAGE Publications, November 2010. ISBN 978-1-4129-7076-1.
Lohrenz, M. C., Trafton, J. G., Beck, M. R., and Gendron, M. L. A model of clutter for complex, multivariate geospatial displays. Human Factors, 51 (1): 90-101. 2009.
Michael, C. J., Acklin. D., and Scheuerman, J. On Interactive Machine Learning and the Potential of Cognitive Feedback. arXiv preprint arXiv: 2003.10365.2020.
Plonsky, O., Erev, 1., Hazan, T., and Tennenholtz, M. Psychological Forest: Predicting Human Behavior, May 2016.
Salvucci, D. D. An integrated model of eye movements and visual encoding. Cognitive Systems Research, 1 (4): 201-220, 2001.
Salvucci, D. D. Modeling driver behavior in a cognitive architecture. Human factors, 48 (2): 362-380, 2006.
Todi. K., Jokinen, J., Luyten. K., and Oulasvirta, A. Familiarisation: Restructuring layouts with visual learning models. In 23rd International Conference on Intelligent User Interfaces, pp. 547-558, 2018.
Trafton, J. G., Hiatt. L. M., Brumback, B., and McCurry, J. M. Using Cognitive Models to Train Big Data Models with Small Data. In Proceedings of the 19th Inernational Conference on Autonomous Agents and MultiAgent Systems, pp. 1413-1421, 2020.
Weinhardt, J. M. and Schaefer, R. Uncertainty definitions and their problems: A new way forward. 2022.

What is claimed is:

1. A method of reducing uncertainty in a machine learning model, the method comprising:
providing, by a processing device, a first set of visual data;
receiving, by the processing device, user input associated with identifying a threshold point in the first set of visual data, the threshold point being associated with a classification task;
identifying, by the processing device via a machine learning model, in the first set of visual data, a machine placement candidate point associated with identifying the threshold point;
identifying, by the processing device and based on the machine placement candidate point, a set of baseline confidence values via a baseline uncertainty model;
identifying, by the processing device and based on the machine placement candidate point and modeled cognitive features, a second set of confidence values via a cognitive uncertainty model;
determining, by the processing device, an actual probability of machine incorrectness based on a distribution associated with machine placement candidate point and the user input associated with identifying the threshold point;
determining, by the processing device, via a baseline uncertainty model, a first prediction that the machine placement candidate point is incorrect;
determining, by the processing device, via a cognitive uncertainty model, a second prediction that the machine placement candidate point is incorrect based on cognitive features associated with a location of the threshold point;
training, by the processing device, the baseline uncertainty model, based on the actual probability of machine incorrectness and the first prediction that the machine placement candidate point is incorrect, wherein the training is based on baseline features associated with the location of the threshold point;
training, by the processing device, the cognitive uncertainty model, based on the actual probability of machine incorrectness and the second prediction that the machine placement is incorrect, wherein the training is based on cognitive features associated with the location of the threshold point;
identifying, by the processing device, via the trained baseline uncertainty model, one or more confidence values associated with a machine placement candidate point for a visual feature in a second set of visual data, the visual feature being associated with the classification task; and
identifying, by the processing device, via the trained cognitive uncertainty model, one or more confidence values associated with a machine placement candidate point for a visual feature in a second set of visual data, the visual feature being associated with the classification task.

2. The method of claim 1, further comprising generating, via the cognitive uncertainty model, modeled feedback associated with the first set of visual data by simulating a user visually scanning and encoding the visual data and then clicking a point in the visual data.

3. The method of claim 2, wherein the cognitive model uses an ACT-R agent to simulate eye movement associated with the user input that occurs as a user scans along the visual data to identify the threshold point in the first set of visual data.

4. The method of claim 3, wherein the first set visual data is a sigmoid curve the threshold point is associated with an inflection point in the first set of visual data.

5. The method of claim 3, wherein the ACT-R agent uses an Eye Movement Measurement and Analysis (EMMA) extension to generate quantitative predictions about eye movements, including the timing of those movements.

6. The method of claim 1, wherein the cognitive features associated with the location of the threshold point comprise timing information associated with the classification task.

7. The method of claim 1, wherein providing the first set of visual data comprises displaying a graph.

8. The method of claim 7, wherein the graph comprises a noisy signal.

9. The method of claim 1, wherein providing the first set of visual data comprises displaying an image.

10. The method of claim 1, wherein the classification task comprises identifying a boundary between a high value and a low value.

11. The method of claim 1, wherein the second set of visual data comprises an image.

12. The method of claim 1, wherein the second set of visual data comprises a graph.

13. The method of claim 1, further comprising identifying, via the cognitive uncertainty model, the visual feature in the second set of visual data.

14. The method of claim 13, wherein identifying the visual feature in the second set of visual data comprises identifying an edge between two regions in the second set of visual data.

15. The method of claim 1, further comprising performing a water-based operation based on the identified visual feature in the second set of visual data.

16. The method of claim 1, wherein determining the actual probability of machine incorrectness further comprises determining one or more tolerance values indicating a maximum distance a machine placement can be from a user placement to be deemed correct.

17. The method of claim 16, wherein determining the one or more tolerance values comprises calculating a mean absolute error.

18. The method of claim 16, wherein the one or more tolerance values range from 0.02 to 0.20.

19. The method of claim 1, wherein the baseline uncertainty model comprises a naive Bayes model.
